(19) United States
(12) Patent Application Publication
(10) Pub. No.: US 2005/0289060 A1
(43) Pub. Date: Dec. 29, 2005

(54) Secure method of consulting article delivery receipts

(76) Inventors: Cyrus Abumehdi, Harlow (GB); Patrick Blanluet, Paris (FR); Axel Glaeser, Tauffelen (CH)

Correspondence Address: PERMAN & GREEN, 425 POST ROAD, FAIRFIELD, CT, 06824, US

(21) Appl. No.: 11/082,224

(22) Filed: Mar. 16, 2005

(30) Foreign Application Priority Data
Mar. 16, 2004 (FR) FR 04 02682

(51) Int. Cl. H04L 9/00

(52) U.S. Cl. 705/50

(57) ABSTRACT

In a secure method of consulting article delivery receipts from a remote computer terminal connected to a management computer center via a telecommunications network, a digital image of each receipt is initially input to a portable terminal that includes a radio interface for transmitting said image to the management computer center. In order to consult the digital image in secure manner from the remote computer terminal, provision is made in said remote computer terminal to use a unique key k_{SESSION} that is different on each consultation in order to decrypt first data E1 generated in the portable terminal from the digital image, said unique key k_{SESSION} itself being the result of the management computer center using one of its own private keys k_{PRIV}^{NLS} to decrypt second data E2 generated in the portable terminal from the unique key k_{SESSION}.

### TECHNICAL FIELD

The present invention relates to the field of logistics as applied to shipping goods, parcels, and packets, or any other article, and it relates more particularly to a secure method of consulting goods delivery receipts.

### PRIOR ART

The logistics systems for tracking articles that are presently in use by carriers are well known. By way of example, U.S. Pat. No. 5,313,051 describes an article tracking system comprising a portable terminal held in the hand of a delivery person and provided with a bar code reader and a touch-sensitive screen and also with radio communications means for transferring information to a central carrier, which claim, in particular the identity and the signature of the addressee, is input via the screen by the delivery person. Such a system enables the carrier to have, in real time, information relating to goods that have been delivered. Nevertheless, that information system cannot be consulted directly by the carrier's clients, nor can those clients consult the information relating to the delivery receipt that constitutes proof of delivery. That can only be consulted by the client after the delivery round has been completed and all of the receipts have been handed over to a scanner center where, after they have been processed, they can be consulted using a telecommunications network.

### OBJECT AND DEFINITION OF THE INVENTION

An object of the present invention is thus to mitigate the above-mentioned drawbacks by means of a method and a system for securely consulting article delivery receipts enabling the client of a carrier to consult in secure manner and in real time the various receipts relating to goods being delivered to their addressees. Another object of the invention is to enable the receipts to be consulted in a manner that is simple, but not secure, and without any guarantee as to content. Another object of the invention is to provide a method that is simple and that limits the amount of information that needs to be exchanged in order to implement the system.

These objects are achieved with a secure method of consulting article delivery receipts from a remote computer terminal connected to a management computer center via a telecommunications network, a digital image of each receipt being initially input to a portable terminal including a radio interface for transmitting the image to the management computer center, wherein in order to consult said digital image in secure manner from the remote computer terminal, it is necessary in said remote computer terminal to use a key k_{SESSION} that is unique and different for each consultation, to decrypt first data E1 generated in the portable terminal from said digital image, said unique key k_{SESSION} itself being the result of the management computer center using a private key k_{PRIV}^{NLS} of the management computer center to decrypt second data E2 generated in the portable terminal from the unique key k_{SESSION}.

Thus, the data input into the portable terminal by the delivery person can be consulted in secure manner on line, e.g. immediately after the data has been input, but only by a user client in possession of means for decrypting the unique session key that has previously been encrypted in the management computer center.

In the intended implementation, a first public key k_{PUB}^{MMT} may be used to verify a signature S1 associated with the digital image, this signature being obtained in the remote computer terminal by using the unique key k_{SESSION} that is different on each consultation to decrypt the first data E1 generated in the portable terminal and transmitted to the management computer center, the unique key k_{SESSION} being obtained in the computer terminal by using a second public key k_{PUB}^{NLS} to decrypt third data E3 generated in the management computer center by using the private key k_{PRIV}^{NLS} of the management computer center to encrypt the unique key k_{SESSION} as obtained previously by using said private key k_{PRIV}^{NLS} to decrypt the second data E2 generated in the portable terminal and transmitted to the management computer center.

It is also possible for a first public key k_{PUB}^{MMT} to be used to verify a signature S1 associated with the digital image, said signature S1 being obtained in the remote computer terminal by using the unique key k_{SESSION} that is different on each consultation to decrypt the first data E1 generated in the portable terminal and transmitted to the management computer center, this unique key k_{SESSION} being transmitted by the management computer center together with a signature S2 associated with said unique key k_{SESSION} and being verified in the remote computer terminal by means of a second public key k_{PUB}^{NLS}, the signature S2 being obtained by using the private key k_{PRIV}^{NLS} of the management computer center to encrypt the unique key k_{SESSION} as obtained previously by using said private k_{PRIV}^{NLS} to decrypt the second data E2 generated in the portable terminal and transmitted to the management computer center.

Preferably, the first data E1 is obtained by using the unique key k_{SESSION} to encrypt the signature S1, and the second data E2 is obtained by using the unique key k_{SESSION} to encrypt the second public key k_{PUB}^{NLS}, the signature S1 itself being the result of the digital image of the receipt being signed with a private key k_{PRIV}^{MMT} of the portable terminal.

In the intended implementation, the first public key k_{PUB}^{MMT} may be encrypted by means of the second public key k_{PUB}^{NLS} to obtain first key data Eₖ₁ which is transmitted to the management computer center where said first key data Eₖ₁ is decrypted using the private key k_{PRIV}^{NLS} of the management computer center in order to recover the first public key k_{PUB}^{MMT}, which key is then encrypted again using the private key k_{PRIV}^{NLS} of the management computer center in order to obtain second key data Eₖ₂ from which the client can recover the first public key k_{PUB}^{MMT} by decrypting the second data key with the second public key k_{PUB}^{NLS}. Advantageously, the first key data Eₖ₁ is transmitted to the management computer center together with the digital image of the receipt and the first and second data E1 and E2.

It is also possible for the first public key k_{PUB}^{MMT} to be signed by means of the private key k_{PRIV}^{NLS} in order to obtain a key signature Sₖ₁ which is transmitted together with the first public key k_{PUB}^{MMT} to the management computer center where said key signature Sₖ₁ is verified by means of the second public key k_{PUB}^{NLS} prior to being retransmitted together with the first public key k_{PUB}^{MMT} to the client terminal where said key signature Sₖ₁ is again verified by means of the second public key k_{PUB}^{NLS}, the result of this verification constituting acceptance or refusal of the first public key k_{PUB}^{MMT}. Advantageously, the key signature Sₖ₁ is transmitted to the management computer center together with the digital image of the receipt and the first and second data E1 and E2.

Preferably, the telecommunications network is the Internet, the encrypting/decrypting process is of the DES, triple DES, or AES type, and the digital image of the receipt is transmitted together with identity data and other information relating to the delivery as input to the portable terminal.

### BRIEF DESCRIPTION OF THE DRAWINGS

The invention will be better understood on sight of the following detailed description accompanied by illustrative and non-limiting examples with reference to the following figures, in which:

FIG. 1 is a general view of a computer network architecture enabling secure consultation of the delivery of articles in accordance with the invention;

FIGS. 2 and 3 show the various steps in two implementations of a process for verifying messages sent by a portable terminal of the FIG. 1 network; and

FIGS. 4 and 5 show different steps in two implementations of a process for transferring keys that is implemented in the network of FIG. 1.

### DETAILED DESCRIPTION OF IMPLEMENTATIONS

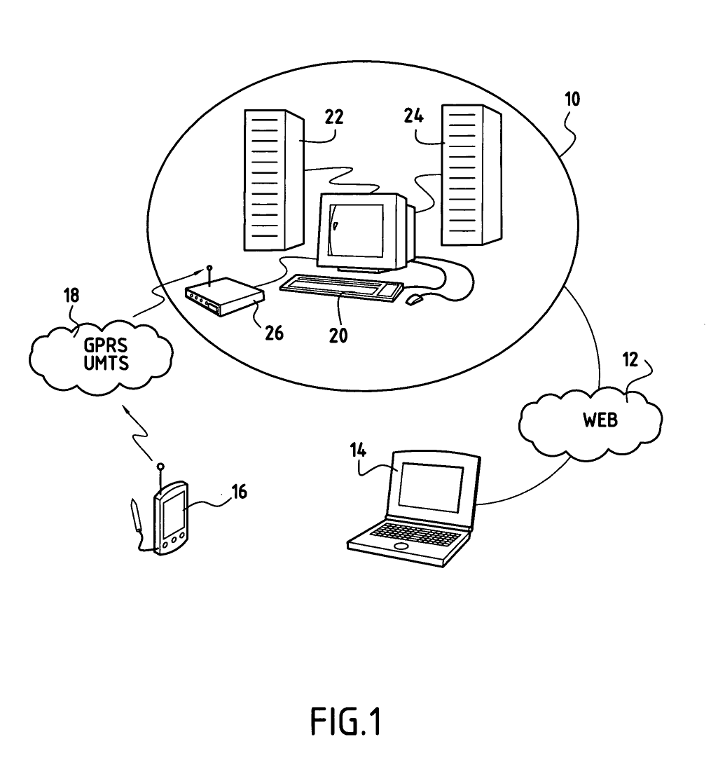

FIG. 1 shows the architecture of a computer network of a carrier of goods, parcels, or packets, or indeed any other article of the same kind, in which it is necessary to implement secure consultation of delivery receipts in accordance with the invention. Nevertheless, it should be observed that it is not essential for the network to belong to the carrier, and that it could equally well belong to a third party acting as the representative of the carrier for receiving receipts and information concerning deliveries.

This network architecture is organized around a management computer center 10 connected to a first telecommunications network 12 of the Internet type. The management computer center comprises one or more computer servers, e.g. a server 20, having databases 22, 24 connected thereto including an image database 22 that is accessible via the Internet from remote computer terminals, e.g. a personal computer 14. The server is also provided with a radio modem 26 to receive data from a multifunction portable terminal 16 via a second telecommunications network 18 of the general packet radio service (GPRS) or universal mobile telephone system (UMTS) type.

With this architecture, it is possible for the client of a carrier to consult in real time the receipts for deliveries of that client's goods to their destinations together with any other information relating to such deliveries and entered into the multifunction portable terminal by an employee of the carrier, generally a driver and delivery person. The consultation can be performed remotely in very simple manner via the Internet 12 from any user station of the client, e.g. a personal computer 14 or any other computer equipment giving access to the Internet (such as a personal digital assistant (PDA)). Naturally, the receipts and the other information relating to delivery as input at the addressee of the goods via the multifunction portable terminal 16 held by the carrier's employee, are previously transmitted via the telecommunications network 18 in real time to the computer center 10 for managing said information.

The detail of the information that is transmitted is given in the patent application filed on the same day by the same Applicant and entitled “An optimized system for tracking the delivery of articles”. That information, in addition to the digital image of the delivery receipt bearing the stamp of the addressee, also includes all useful information relating to receipt of the goods by the addressee, such as the name of the addressee, the date and time of delivery, the number of parcels delivered, possibly the number of parcels refused, the signature and the name of the person signing the delivery receipt, and possibly any reservations about the delivery. In addition, a photograph (a digital image) of a refused parcel and/or of the addressee, or indeed a voice comment made by the driver or by the addressee may advantageously be associated with the above information, as can the number of equipments on deposit sorted by type of equipment or payment of transport costs or payment for cash-on-delivery (COD).

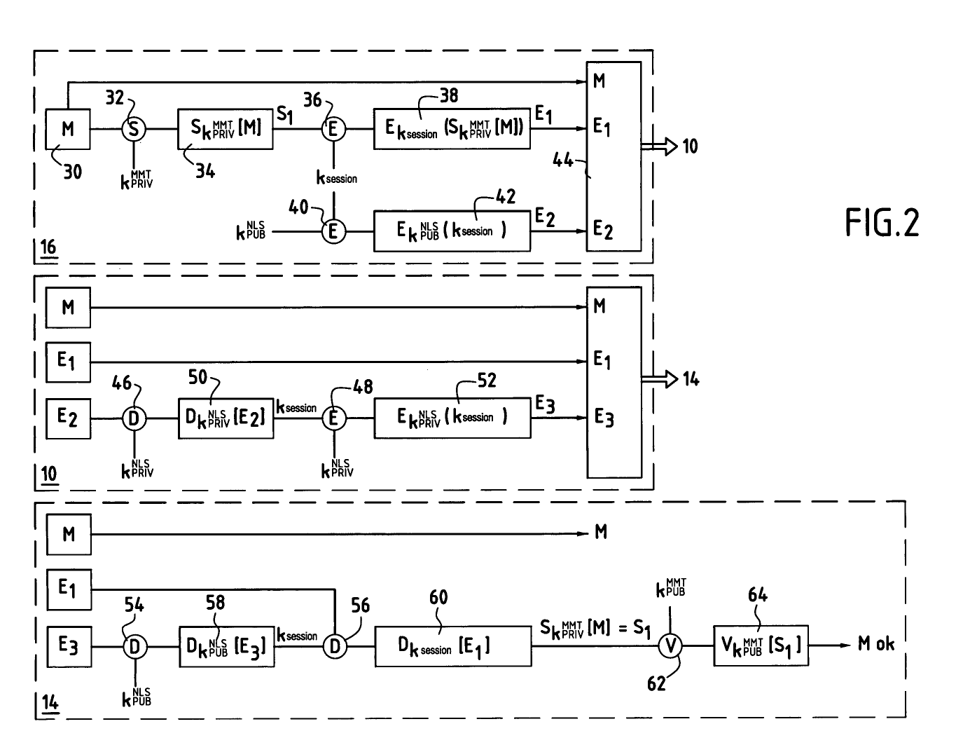

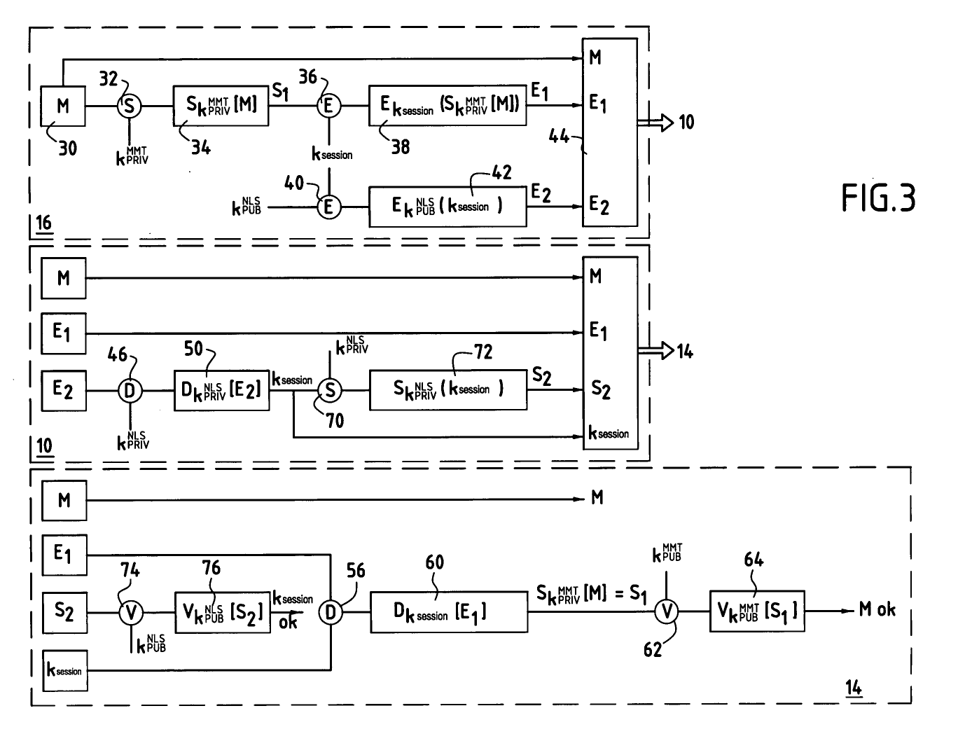

According to the invention, all of this information is transmitted over the network, and is subsequently consulted, in secure manner in order to guarantee to the client that the information has not been tampered with. The secure consultation method that provides this guarantee of transmission is described below with reference to FIGS. 2 to 5. It relies on encryption protocols and on protocols for creating signatures described with reference to FIGS. 2 and 3.

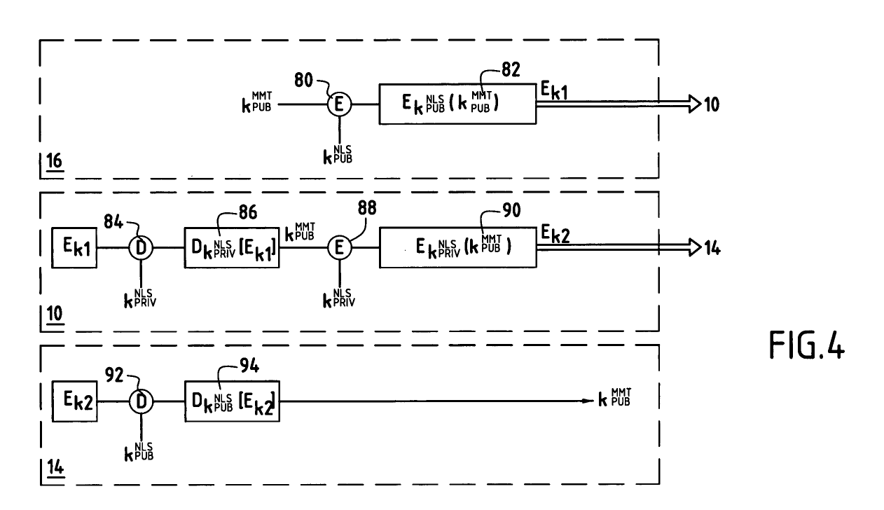

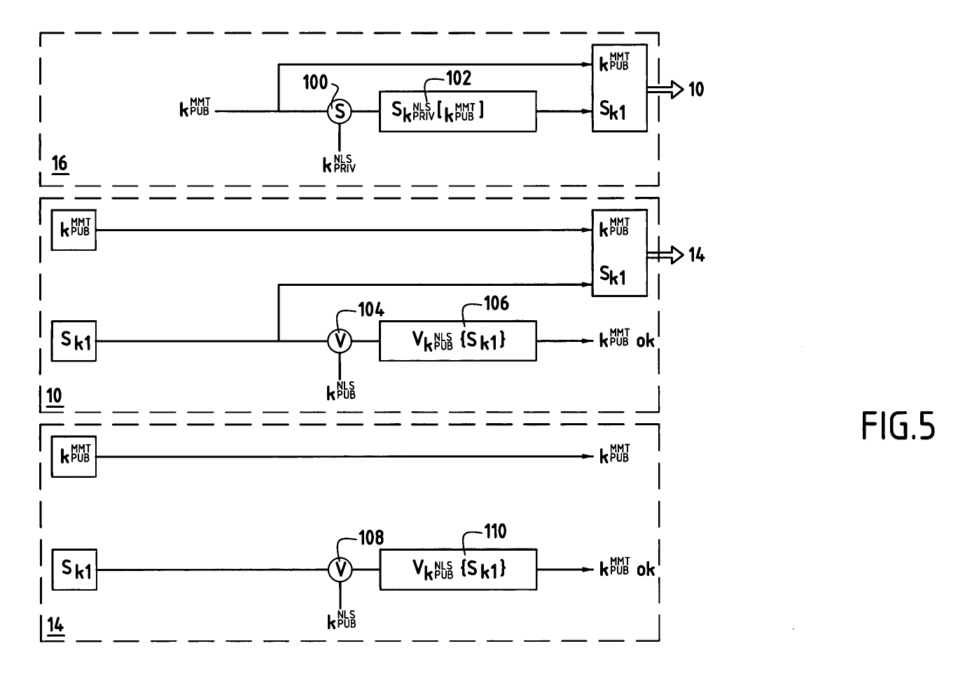

Implementation of the method assumes prior creation of four keys which are stored in the multifunction portable terminal before any use thereof, preferably when it is manufactured or when the terminal is put into operation in the premises of the carrier or its representative. The first two keys are specific to the terminal and comprise a terminal private key k_{PRIV}^{MMT} and a first public key k_{PUB}^{MMT}. The other two keys are specific to the carrier and likewise comprise a private key, this time for the management computer center k_{PRIV}^{NLS} and a second public key k_{PUB}^{NLS}. By their nature, the two private keys are unknown to the client or to any person other than the carrier or the carrier's representative, while the two public keys are freely available to the client. They may nevertheless themselves constitute the subject matter of the key exchange process described with reference to FIGS. 4 and 5.

FIG. 2 shows a first example of the secure consultation method of the invention. The message 30 transmitted by the multifunction portable terminal is initially signed 32 by means of the private key k_{PRIV}^{MMT} of the portable terminal in order to obtain a signature S1. Then, by means of a unique key generated in the terminal and referred to as k_{SESSION}, this signature 34 is encrypted 36 to deliver 38 first encrypted data E1. In parallel, this unique key is encrypted 40 using the second public key k_{PUB}^{NLS} to deliver 42 second encrypted data E2. Once the first and second encrypted data items have been delivered, they are sent 44 to the management computer center together with the message M (which is thus transmitted in the clear) that was used for creating them.

When the management computer center receives the data items E1 and E2 together with the message M, it begins by recovering the unique key k_{SESSION} by decrypting 46 the data E2 using the management computer center's private key k_{PRIV}^{NLS}, and then it encrypts 48 this key 50 again by means of the private key k_{PRIV}^{NLS} to obtain 52 third encrypted data E3.

Then, providing the client can establish a connection to the management computer center, possibly together with an account number and a password for example, the client can use the Internet to access the message M and thus freely consult the data transmitted by the terminal, thereby gaining access almost at the time of delivery to all of the data relating to the delivery, and in particular to the data constituting proof of delivery, i.e. the image of the delivery receipt carrying the stamp of the addressee, the identity and the signature of the person who received the goods, and the date and time of delivery. Nevertheless, at this stage, the data is still raw data and has not been subjected to any verification process that could guarantee its validity. In order to access such a process, the client needs to make a request to the management computer center which then also gives the client access to the data items E1 and E3.

Starting from E3, the client can use a personal computer to recover the key k_{SESSION} by decrypting 54 said data using the second public key k_{PUB}^{NLS}. Then, by decrypting 56 the data item E1 using the key 58 as obtained in this way, it is possible to obtain 60 the signature S1 associated with the message M, which signature S1 can then be used to verify 62 validity by means of the first public key k_{PUB}^{MMT}. The result of this verification consists in the content of the message M being accepted or refused 64.

FIG. 3 shows a second example of the secure consultation method of the invention. As in the preceding example, the process of transferring the message to the management computer center is unchanged. Thus, the message 30 transmitted by the multifunction portable terminal is initially signed 32 by means of the portable terminal's private key k_{PRIV}^{MMT} in order to obtain a signature S1. Then, the unique key k_{SESSION} generated by the terminal is used to encrypt 36 the signature S1 in order to deliver 38 first encrypted data E1. In parallel, the unique key is encrypted 40 by means of the second public key k_{PUB}^{NLS} in order to deliver 42 second encrypted key E2. Once the first and second encrypted data items have been delivered, they are sent 44 to the management computer center together with the message M (which is thus transmitted in the clear) that was used for creating them. However, the processing in the management computer center is slightly different.

When the management computer center receives the data E1 and E2 together with the message M, it begins by recovering the unique key k_{SESSION} by decrypting 46 the data E2 using the private key k_{PRIV}^{NLS} of the management computer center, but instead of encrypting the unique key again, it signs 70 it using the private key k_{PRIV}^{NLS} in order to obtain a second signature S2. At this stage, as before, the client can consult the message M but without guarantee. However, if the client desires the message to be validated, the client needs to make a request to the computer center, which will then give the client access also to the first data E1, to the second signature S2, and to the unique key k_{SESSION}.

The client can then use the personal computer to verify the validity of the key k_{SESSION} by verifying 74 the signature S2 by means of the second public key k_{PUB}^{NLS}, the result of this verification consisting in the received key being accepted or refused 76. If this test is positive, the client can then decrypt 56 the data E1 on the basis of the validated unique key k_{SESSION}, thereby obtaining 60 the signature S1 associated with the message M, which signature S1 can then be used to verify 62 validity by means of the first public key k_{PUB}^{MMT}. The result of this verification constitutes acceptance or refusal 64 of the content of the message M.

In the two above examples, it is assumed that the client has available the first public key k_{PUB}^{MMT} enabling the signature of the message M to be verified. However, it is also possible to envisage that this key is transferred to the client's computer from the multifunction personal terminal via the management computer center, as shown in FIGS. 4 and 5.

In FIG. 4, the transfer relies on an encryption process. The first public key k_{PUB}^{MMT} is initially encrypted 80 by means of the second public key k_{PUB}^{NLS} in order to obtain first key data Eₖ₁ which is transmitted to the management computer center together with the message M and the data E1 and E2. In the management computer center, the key data Eₖ₁ is decrypted 84 by means of the private key k_{PRIV}^{NLS} in order to obtain 86 the initial key k_{PUB}^{MMT} which is again encrypted 88, but this time using the private key k_{PRIV}^{NLS} in order to deliver 90 second key data Eₖ₂. It is from this second key data Eₖ₂ that the client can then recover 92 the first public key k_{PUB}^{MMT} by decrypting with the second public key k_{PUB}^{NLS}.

In FIG. 5, the above transfer relies on a process for creating a signature. The first public key k_{PUB}^{MMT} is initially signed 100 using the private key k_{PRIV}^{NLS} of the management computer center in order to obtain 102 a key signature Sₖ₁. This key signature Sₖ₁ is then transmitted together with the first public key k_{PUB}^{MMT} to the management computer center together with the message M and the data E1 and E2. At the management computer center, the key signature Sₖ₁ is verified 104 by means of the second public key k_{PUB}^{NLS}, with the result of the verification 106 constituting acceptance or refusal of the received first public key k_{PUB}^{MMT}. The client can then use a terminal to access the key signature Sₖ₁ and can in turn verify 108 this signature by means of the second public key k_{PUB}^{NLS}, the result of this verification 110 constituting acceptance or refusal of the first public key k_{PUB}^{MMT}.

In all of the above exchanges, the encryption/decryption process relies on using a conventional algorithm of the DES, triple DES, or AES type well known to the person skilled in the art and to which reference can be made if necessary.

Thus, with the method of the invention, the client can consult all of the information concerning the delivery (including equipment on deposit, sums received, for example), on line and from any location, because access is made via the Internet. In addition, the associated verification process relying on encryption or on a transmitted data signature enables the client to establish evidence of delivery of the goods of a kind that is suitable for constituting legally-enforceable proof.

1. A secure method of consulting article delivery receipts from a remote computer terminal connected to a management computer center via a telecommunications network, a digital image of each receipt being initially input to a portable terminal including a radio interface for transmitting the image to the management computer center, wherein in order to consult said digital image in secure manner from the remote computer terminal, it is necessary in said remote computer terminal to use a key k_{SESSION} that is unique and different for each consultation, to decrypt a first data E1 generated in the portable terminal from said digital image, said unique key k_{SESSION} itself being the result of the management computer center using a private key k_{PRIV}^{NLS} of the management computer center to decrypt, second data E2 generated in the portable terminal from the unique key k_{SESSION}.

2. A secure method of consulting article delivery receipts according to claim 1, wherein a first public key k_{PUB}^{MMT} is used to verify a signature S1 associated with the digital image, this signature being obtained in the remote computer terminal by using the unique key k_{SESSION} that is different on each consultation to decrypt the first data E1 generated in the portable terminal and transmitted to the management computer center, the unique key k_{SESSION} being obtained in the computer terminal by using a second public key k_{PUB}^{NLS} to decrypt third data E3 generated in the management computer center by using the private key k_{PRIV}^{NLS} of the management computer center to encrypt the unique key k_{SESSION} as obtained previously by using said private key k_{PRIV}^{NLS} to decrypt the second data E2 generated in the portable terminal and transmitted to the management computer center.

3. A secure method of consulting article delivery receipts according to claim 1, wherein a first public key k_{PUB}^{MMT} is used to verify a signature S1 associated with the digital image, said signature S1 being obtained in the remote computer terminal by using the unique key k_{SESSION} that is different on each consultation to decrypt the first data E1 generated in the portable terminal and transmitted to the management computer center, this unique key k_{SESSION} being transmitted by the management computer center together with a signature S2 associated with said unique key k_{SESSION} and being verified in the remote computer terminal by means of a second public key k_{PUB}^{NLS}, the signature S2 being obtained by using the private key k_{PRIV}^{NLS} of the management computer center to encrypt the unique key k_{SESSION} as obtained previously by using said private k_{PRIV}^{NLS} to decrypt the second data E2 generated in the portable terminal and transmitted to the management computer center.

4. A secure method of consulting article delivery receipts according to claim 2, wherein the first data E1 is obtained by using the unique key k_{SESSION} to encrypt the signature S1, and the second data E2 is obtained by using the unique key k_{SESSION} to encrypt the second public key k_{PUB}^{NLS}, the signature S1 itself being the result of the digital image of the receipt being signed with a private key k_{PRIV}^{MMT} of the portable terminal.

5. A secure method of consulting article delivery receipts according to claim 2, wherein the first public key k_{PUB}^{MMT} is encrypted by means of the second public key k_{PUB}^{NLS} to obtain first key data Eₖ₁ which is transmitted to the management computer center where said first key data Eₖ₁ is decrypted using the private key k_{PRIV}^{NLS} of the management computer center in order to recover the first public key k_{PUB}^{MMT}, which key is then encrypted again using the private key k_{PRIV}^{NLS} of the management computer center in order to obtain second key data Eₖ₂ from which the client can recover the first public key k_{PUB}^{MMT} by decrypting the second data key with the second public key k_{PUB}^{NLS}.

6. A secure method of consulting article delivery receipts according to claim 5, wherein the first key data Eₖ₁ is transmitted to the management computer center together with the digital image of the receipt and the first and second data E1 and E2.

7. A secure method of consulting article delivery receipts according to claim 2, wherein the first public key k_{PUB}^{MMT} is signed by means of the private key k_{PRIV}^{NLS} in order to obtain a key signature Sₖ₁ which is transmitted together with the first public key k_{PUB}^{MMT} to the management computer center where said key signature Sₖ₁ is verified by means of the second public key k_{PUB}^{NLS} prior to being retransmitted together with the first public key k_{PUB}^{MMT} to the client terminal where said key signature Sₖ₁ is again verified by means of the second public key k_{PUB}^{NLS}, the result of this verification constituting acceptance or refusal of the first public key k_{PUB}^{MMT}.

8. A secure method of consulting article delivery receipts according to claim 7, wherein the key signature Sₖ₁ is transmitted to the management computer center together with the digital image of the receipt and the first and second data E1 and E2.

9. A secure method of consulting article delivery receipts according to claim 1, wherein the telecommunications network is the Internet.

10. A secure method of consulting article delivery receipts according to claim 1, wherein the encrypting/decrypting process is of the DES, triple DES, or AES type.

11. A secure method of consulting article delivery receipts according to claim 1, wherein the digital image of the receipt is transmitted together with identity data and other information relating to the delivery as input to the portable terminal.
